(19) United States
(12) Patent Application Publication
(10) Pub. No.: US 2023/0049922 A1
(43) Pub. Date: Feb. 16, 2023

(54) CONTROL APPARATUS, CONTROL METHOD, AND NON-TRANSITORY COMPUTER READABLE MEDIUM

(71) Applicant: TOYOTA JIDOSHA KABUSHIKI KAISA, Toyota-shi (JP)

(72) Inventors: Toyokazu NAKASHIMA, Nagoya-shi (JP); Takeshi TAKEMOTO, Nagoya-shi (JP); Naoko YAMAFUJI, Nagoya-shi (JP); Naoya OKA, Nagakute-shi (JP)

(73) Assignee: TOYOTA JIDOSHA KABUSHIKI KAISA, Toyota-shi (JP)

(21) Appl. No.: 17/818,153

(22) Filed: Aug. 8, 2022

(30) Foreign Application Priority Data
Aug. 11, 2021 (JP) 2021-131458

(51) Int. Cl. G07C 5/12; G07C 5/08; G07C 5/00

(52) U.S. Cl. CPC G07C 5/12; G07C 5/0808; G07C 5/0825; G07C 5/008; G06Q 30/0278

(57) ABSTRACT

A control apparatus includes a controller configured to acquire, based on whether a vehicle selected by a user has an accident history, at least one piece of change information indicating a change in performance of the vehicle before and after an accident and output the acquired change information.

### CROSS-REFERENCE TO RELATED APPLICATION

This application claims priority to Japanese Patent Application No. 2021-131458 filed on Aug. 11, 2021, the entire contents of which are incorporated herein by reference.

### TECHNICAL FIELD

The present disclosure relates to a control apparatus, a control method, and a program.

### BACKGROUND

Patent literature (PTL) 1 describes technology for performing an appraisal of a used vehicle based on the condition of the vehicle and providing the result to the user.

### CITATION LIST

### Patent Literature

PTL 1: JP 2012-174102 A

### SUMMARY

The technology described in PTL 1 does not consider the possibility of varying the evaluation among vehicles with an accident history, and there is room for improvement in methods for providing information that affects the appraisal when a vehicle has an accident history.

It would be helpful to improve a method of providing information that affects the appraisal when a vehicle has an accident history.

A control apparatus according to the present disclosure includes a controller configured to:

acquire, based on whether a vehicle selected by a user has an accident history, at least one piece of change information indicating a change in performance of the vehicle before and after an accident and output the acquired change information.

A control method according to the present disclosure is a control method to be executed by a computer and includes:

acquiring, based on whether a vehicle selected by a user has an accident history, at least one piece of change information indicating a change in performance of the vehicle before and after an accident and outputting the acquired change information.

A program according to the present disclosure is configured to cause a computer to execute operations, the operations including:

acquiring, based on whether a vehicle selected by a user has an accident history, at least one piece of change information indicating a change in performance of the vehicle before and after an accident and outputting the acquired change information.

According to the present disclosure, a method of providing information that affects the appraisal when a vehicle has an accident history can be improved.

### BRIEF DESCRIPTION OF THE DRAWINGS

In the accompanying drawings:

FIG. 1 is a diagram illustrating a configuration of a system according to an embodiment of the present disclosure;

FIG. 2 is a block diagram illustrating a configuration of a control apparatus according to the embodiment of the present disclosure;

FIG. 3 is a block diagram illustrating a configuration of a terminal apparatus according to the embodiment of the present disclosure;

FIG. 4 is a block diagram illustrating a configuration of a vehicle according to an embodiment of the present disclosure;

FIG. 5 is a diagram illustrating an example of change information according to an embodiment of the present disclosure;

FIG. 6 is a diagram illustrating an example of change information according to an embodiment of the present disclosure;

FIG. 7 is a diagram illustrating an example of change information according to an embodiment of the present disclosure;

FIG. 8 is a diagram illustrating an example of change information according to an embodiment of the present disclosure;

FIG. 9 is a diagram illustrating operations of a system according to an embodiment of the present disclosure;

FIG. 10 is a diagram illustrating operations of a system according to a first variation;

FIG. 11 is a diagram illustrating operations of a system according to a second variation; and

FIG. 12 is a block diagram illustrating a configuration of a control apparatus according to the second variation.

### DETAILED DESCRIPTION

Hereinafter, an embodiment of the present disclosure will be described with reference to the drawings.

In the drawings, the same or corresponding portions are denoted by the same reference numerals. In the descriptions of the present embodiment, detailed descriptions of the same or corresponding portions are omitted or simplified, as appropriate.

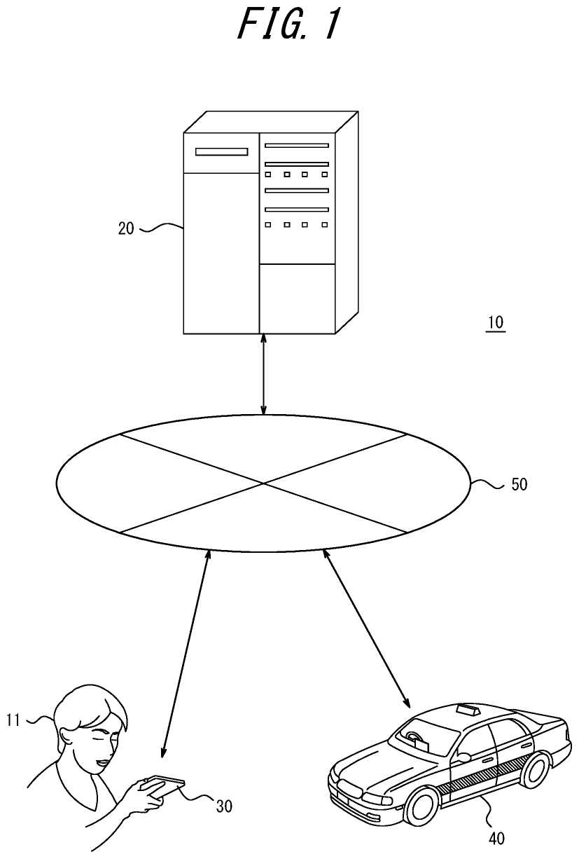

An outline of a system 10 according to an embodiment of the present disclosure will be described with reference to FIG. 1. The system 10 includes a control apparatus 20, a terminal apparatus 30, and a vehicle 40. The control apparatus 20, the terminal apparatus 30, and the vehicle 40 are communicably connected via a network 50.

The control apparatus 20 is installed in a facility such as a data center. The control apparatus 20 is a computer such as a server that belongs to a cloud computing system or another type of computing system.

The terminal apparatus 30 is held by a user 11. The terminal apparatus 30 is, for example, a mobile device such as a mobile phone, a smartphone, a wearable device, or a tablet, or a PC. The term “PC” is an abbreviation of personal computer. Users 11 include prospective purchasers of the vehicle 40 as a used vehicle and people in charge at the dealership of the vehicle 40.

The vehicle 40 is, for example, any type of automobile such as a gasoline vehicle, a diesel vehicle, a hydrogen vehicle, an HEV, a PHEV, a BEV, or an FCEV. The term “HEV” is an abbreviation of hybrid electric vehicle. The term “PHEV” is an abbreviation of plug-in hybrid electric vehicle. The term “BEV” is an abbreviation of battery electric vehicle. The term “FCEV” is an abbreviation of fuel cell electric vehicle. The vehicle 40 is driven by a driver in the present embodiment, but the driving may be automated at any level. The automation level is, for example, any one of Level 1 to Level 5 according to the level classification defined by SAE. The name “SAE” is an abbreviation of Society of Automotive Engineers. The vehicle 40 may be a MaaS-dedicated vehicle. The term “MaaS” is an abbreviation of Mobility as a Service.

The network 50 includes the Internet, at least one WAN, at least one MAN, or any combination thereof. The term “WAN” is an abbreviation of wide area network. The term “MAN” is an abbreviation of metropolitan area network. The network 50 may include at least one wireless network, at least one optical network, or any combination thereof. The wireless network is, for example, an ad hoc network, a cellular network, a wireless LAN, a satellite communication network, or a terrestrial microwave network. The term “LAN” is an abbreviation of local area network.

First, an outline of the present embodiment will be described, and details thereof will be described later. Based on whether the vehicle 40 selected by the user 11 has an accident history, the control apparatus 20 acquires at least one piece of change information indicating a change in the performance of the vehicle 40 before and after an accident and outputs the acquired change information.

The “change information” is information indicating a change in the performance of the vehicle 40 before and after an accident of the vehicle 40, as explained in more detail below. The “performance” includes any type of performance, such as driving performance, stopping performance, or steering performance, that affects the appraisal of the vehicle 40.

According to the present embodiment, in a case in which the vehicle 40 selected by the user 11 has an accident history, the control apparatus 20 can present the user 11 with the changes in the performance of the vehicle 40 before and after an accident. By referring to the change information, the user 11 can learn not only the most recent condition of the vehicle 40, but also details on what changes in performance have occurred before and after an accident. A method of providing information that affects the appraisal when the vehicle 40 has an accident history can thus be improved.

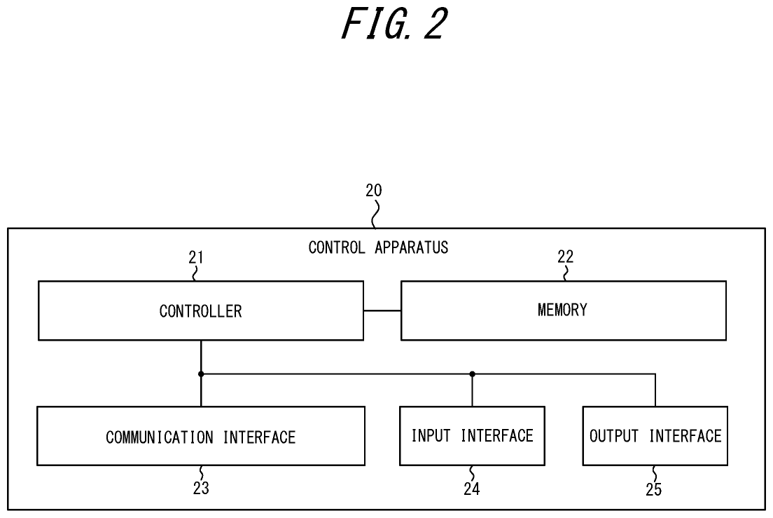

A configuration of the control apparatus 20 according to the present embodiment will be described with reference to FIG. 2.

The control apparatus 20 includes a controller 21, a memory 22, a communication interface 23, an input interface 24, and an output interface 25.

The controller 21 includes at least one processor, at least one dedicated circuit, or a combination thereof. The processor is a general purpose processor such as a CPU or a GPU, or a dedicated processor that is dedicated to specific processing. The term “CPU” is an abbreviation of central processing unit. The term “GPU” is an abbreviation of graphics processing unit. The dedicated circuit is, for example, an FPGA or an ASIC. The term “FPGA” is an abbreviation of field-programmable gate array. The term “ASIC” is an abbreviation of application specific integrated circuit. The controller 21 executes processes related to operations of the control apparatus 20 while controlling components of the control apparatus 20.

The memory 22 includes at least one semiconductor memory, at least one magnetic memory, at least one optical memory, or a combination of at least two of these. The semiconductor memory is, for example, RAM or ROM. The term “RAM” is an abbreviation of random access memory. The term “ROM” is an abbreviation of read only memory. The RAM is, for example, SRAM or DRAM. The term “SRAM” is an abbreviation of static random access memory. The term “DRAM” is an abbreviation of dynamic random access memory. The ROM is, for example, EEPROM. The term “EEPROM” is an abbreviation of electrically erasable programmable read only memory. The memory 22 functions as, for example, a main memory, an auxiliary memory, or a cache memory. The memory 22 stores information to be used for the operations of the control apparatus 20 and information obtained by the operations of the control apparatus 20. The memory 22 stores system programs, application programs, and the like.

The communication interface 23 includes at least one interface for communication. The interface for communication is, for example, a LAN interface. The communication interface 23 receives information to be used for the operations of the control apparatus 20, and transmits information obtained by the operations of the control apparatus 20.

The input interface 24 includes at least one interface for input. The interface for input is, for example, a physical key, a capacitive key, a pointing device, a touch screen integrally provided with a display, or a microphone. The input interface 24 accepts an operation for inputting information to be used for the operations of the control apparatus 20. The input interface 24 may, instead of being included in the control apparatus 20, be connected to the control apparatus 20 as an external input device. As the connection method, any technology such as USB, HDMI® (HDMI is a registered trademark in Japan, other countries, or both), or Bluetooth® (Bluetooth is a registered trademark in Japan, other countries, or both) can be used. The term “USB” is an abbreviation of Universal Serial Bus. The term “HDMI®” is an abbreviation of High-Definition Multimedia Interface.

The output interface 25 includes at least one interface for output. The interface for output is, for example, a display or a speaker. The display is, for example, an LCD or an organic EL display. The term “LCD” is an abbreviation of liquid crystal display. The term “EL” is an abbreviation of electro luminescence. The output interface 25 outputs information obtained by the operations of the control apparatus 20. The output interface 25 may, instead of being included in the control apparatus 20, be connected to the control apparatus 20 as an external output device. As the connection method, any technology such as USB, HDMI®, or Bluetooth® can be used.

The functions of the control apparatus 20 are realized by execution of a control program according to the present embodiment by a processor corresponding to the controller 21. That is, the functions of the control apparatus 20 are realized by software. The control program causes a computer to execute the operations of the control apparatus 20, thereby causing the computer to function as the control apparatus 20. That is, the computer executes the operations of the control apparatus 20 in accordance with the control program to thereby function as the control apparatus 20.

The program can be recorded on a non-transitory computer readable medium. The non-transitory computer readable medium is, for example, a magnetic recording device, an optical disc, a magneto-optical recording medium, or a semiconductor memory. The program is distributed by sale, transfer of ownership, or rental of a portable recording medium such as a DVD or a CD-ROM on which the program is recorded. The term “DVD” is an abbreviation of digital versatile disc. The term “CD-ROM” is an abbreviation of compact disc read only memory. The program may be distributed by storing the program in a storage of a server and transferring the program from the server to another computer. The program may be provided as a program product.

The computer temporarily stores in a main memory, for example, a program recorded on a portable recording medium, or a program transferred from the server. Then, the computer reads the program stored in the main memory using a processor, and executes processes in accordance with the read program using the processor. The computer may read a program directly from the portable recording medium, and execute processes in accordance with the program. The computer may, each time a program is transferred from the server to the computer, sequentially execute processes in accordance with the received program. Instead of transferring a program from the server to the computer, processes may be executed by a so-called ASP type service that realizes functions only by execution instructions and result acquisitions. The term “ASP” is an abbreviation of application service provider. Programs encompass information that is to be used for processing by an electronic computer and is thus equivalent to a program. For example, data that is not a direct command to a computer but has a property that regulates processing of the computer is “equivalent to a program” in this context.

Some or all of the functions of the control apparatus 20 may be realized by a dedicated circuit corresponding to the controller 21. That is, some or all of the functions of the control apparatus 20 may be realized by hardware.

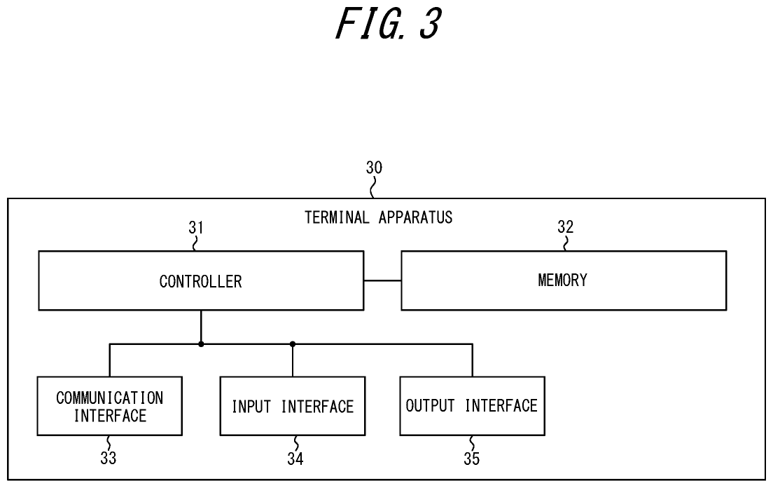

A configuration of the terminal apparatus 30 according to the present embodiment will be described with reference to FIG. 3.

The terminal apparatus 30 includes a controller 31, a memory 32, a communication interface 33, an input interface 34, and an output interface 35.

The controller 31 includes at least one processor, at least one dedicated circuit, or a combination thereof. The processor is a general purpose processor such as a CPU or a GPU, or a dedicated processor that is dedicated to specific processing. The dedicated circuit is, for example, an FPGA or an ASIC. The controller 31 executes processes related to operations of the terminal apparatus 30 while controlling components of the terminal apparatus 30.

The memory 32 includes at least one semiconductor memory, at least one magnetic memory, at least one optical memory, or a combination of at least two of these. The semiconductor memory is, for example, RAM or ROM. The RAM is, for example, SRAM or DRAM. The ROM is, for example, EEPROM. The memory 32 functions as, for example, a main memory, an auxiliary memory, or a cache memory. The memory 32 stores information to be used for the operations of the terminal apparatus 30 and information obtained by the operations of the terminal apparatus 30.

The communication interface 33 includes at least one interface for communication. The interface for communication is, for example, an interface compliant with a mobile communication standard such as LTE, the 4G standard, or the 5G standard, an interface compliant with a short-range wireless communication standard such as Bluetooth®, or a LAN interface. The term “LTE” is an abbreviation of Long Term Evolution. The term “4G” is an abbreviation of 4th generation. The term “5G” is an abbreviation of 5th generation. The communication interface 33 receives information to be used for the operations of the terminal apparatus 30, and transmits information obtained by the operations of the terminal apparatus 30.

The input interface 34 includes at least one interface for input. The interface for input is, for example, a physical key, a capacitive key, a pointing device, a touch screen integrally provided with a display, or a microphone. The input interface 34 accepts an operation for inputting information to be used for the operations of the terminal apparatus 30. The input interface 34 may, instead of being included in the terminal apparatus 30, be connected to the terminal apparatus 30 as an external input device. As the connection method, any technology such as USB, HDMI®, or Bluetooth® can be used.

The output interface 35 includes at least one interface for output. The interface for output is, for example, a display, a speaker, or a vibration motor. The display is, for example, an LCD or an organic EL display. The output interface 35 outputs information obtained by the operations of the terminal apparatus 30. The output interface 35 may, instead of being included in the terminal apparatus 30, be connected to the terminal apparatus 30 as an external output device. As the connection method, any technology such as USB, HDMI®, or Bluetooth® can be used.

The functions of the terminal apparatus 30 are realized by execution of a terminal program according to the present embodiment by a processor corresponding to the controller 31. That is, the functions of the terminal apparatus 30 are realized by software. The terminal program causes a computer to execute the operations of the terminal apparatus 30, thereby causing the computer to function as the terminal apparatus 30. That is, the computer executes the operations of the terminal apparatus 30 in accordance with the terminal program to thereby function as the terminal apparatus 30.

Some or all of the functions of the terminal apparatus 30 may be realized by a dedicated circuit corresponding to the controller 31. That is, some or all of the functions of the terminal apparatus 30 may be realized by hardware.

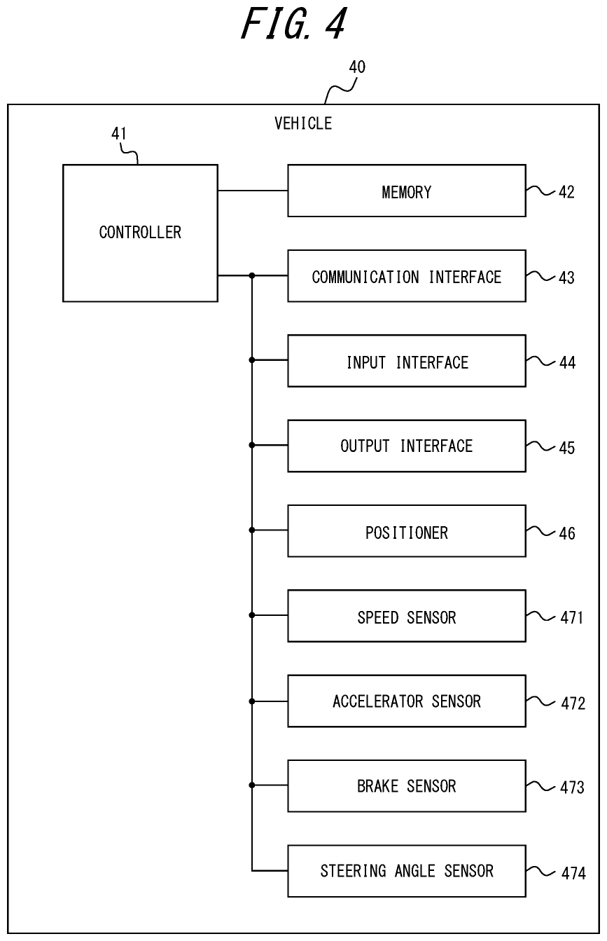

Referring to FIG. 4, a configuration of the vehicle 40 according to the present embodiment will be described.

The vehicle 40 includes a controller 41, a memory 42, a communication interface 43, an input interface 44, an output interface 45, a positioner 46, a speed sensor 471, an accelerator sensor 472, a brake sensor 473, and a steering angle sensor 474. The controller 41, the memory 42, the communication interface 43, the input interface 44, the output interface 45, the positioner 46, the speed sensor 471, the accelerator sensor 472, the brake sensor 473, and the steering angle sensor 474 may be communicably connected to an in-vehicle network, such as a Controller Area Network (CAN).

The controller 41 includes at least one processor, at least one programmable circuit, at least one dedicated circuit, or a combination of these. The processor is a general purpose processor such as a CPU or a GPU, or a dedicated processor that is dedicated to specific processing, for example, but is not limited to these. The programmable circuit is an FPGA, for example, but is not limited to this. The dedicated circuit is an ASIC, for example, but is not limited to this. The controller 41 may include one or more electronic control units (ECUs). The controller 41 controls operations of the vehicle 40 overall while controlling the various components of the vehicle 40.

The memory 42 includes one or more memories. The memories are semiconductor memories, magnetic memories, optical memories, or the like, for example, but are not limited to these. The memories included in the memory 42 may each function as, for example, a main memory, an auxiliary memory, or a cache memory. The memory 42 stores any information used for operations of the vehicle 40. For example, the memory 42 may store a system program, an application program, a database, and the like. The information stored in the memory 42 may be updated with, for example, information acquired from the network via the communication interface 43.

The communication interface 43 includes at least one interface for communication. The interface for communication is compliant with, for example, a mobile communication standard, mobile communication standards such as 4G or 5G, a wired LAN standard, or a wireless LAN standard but is not limited to these and may be compliant with any communication standard. The communication interface 43 receives information to be used for the operations of the vehicle 40 and transmits information obtained by the operations of the vehicle 40.

The input interface 44 includes at least one interface for input. The interface for input is, for example, a physical key, a capacitive key, a pointing device, a touch screen integrally provided with a display, or a microphone. The input interface 44 accepts an operation for inputting information to be used for the operations of the vehicle 40. The input interface 44 may be connected to the vehicle 40 as an external input device, instead of being provided to the vehicle 40. As the connection method, any technology such as USB, HDMI®, or Bluetooth® can be used.

The output interface 45 includes at least one interface for output. The interface for output is, for example, a display or a speaker. The display is, for example, an LCD or an organic EL display. The output interface 45 outputs information obtained by the operations of the vehicle 40. The output interface 45 may, instead of being included in the vehicle 40, be connected to the vehicle 40 as an external output device. As the connection method, any technology such as USB, HDMI®, or Bluetooth® can be used.

The positioner 46 includes at least one GNSS receiver. The term “GNSS” is an abbreviation of global navigation satellite system. GNSS includes, for example, GPS, QZSS, BeiDou, GLONASS, and/or Galileo. The term “GPS” is an abbreviation of Global Positioning System. The term “QZSS” is an abbreviation of Quasi-Zenith Satellite System. QZSS satellites are called quasi-zenith satellites. The term “GLONASS” is an abbreviation of Global Navigation Satellite System. The positioner 46 measures the position of the vehicle 40. The result of measurement by the positioner 46 is acquired by the controller 41 as positional information for the vehicle 40. The “positional information” is information that can identify the position of the vehicle 40, and includes, for example, the coordinates of the vehicle 40.

The speed sensor 471 detects the speed of the vehicle and outputs a signal indicating the detection result to the controller 21. The speed sensor 471 may also be able to act as an acceleration sensor and detect the acceleration, deceleration, or the like of the vehicle 40. The accelerator sensor 472 detects the position, i.e., the amount of depression, of the accelerator of the vehicle 40 and outputs a signal indicating the detection result to the controller 21. The brake sensor 473 detects the position, i.e., the amount of depression, of the brake pedal of the vehicle 40 and outputs a signal indicating the detection result to the controller 21. The steering angle sensor 474 detects the angle of rotation of the steering wheel of the vehicle 40 and outputs a signal indicating the detection result to the controller 21.

The above examples are not limiting, and the vehicle 40 may include various other sensors. Examples of sensors include a brake pressure sensor that detects brake pressure, an ignition sensor, a front vehicle distance sensor, a rear vehicle distance sensor, a driving lane detection sensor, an image sensor, a sensor that detects tire alignment distortion in the vehicle 40, a fuel level sensor, a battery level sensor, a cabin temperature sensor, a water temperature sensor, an oil pressure detection sensor, and an air conditioning sensor.

The functions of the vehicle 40 are realized by execution of any appropriate vehicle program by a processor as the controller 41. That is, the functions of the vehicle 40 are realized by software. The vehicle program causes a computer to execute the operations of the vehicle 40, thereby causing the computer to function as the vehicle 40. That is, the computer executes the operations of the vehicle 40 in accordance with the vehicle program to thereby function as the vehicle 40.

Some or all of the functions of the vehicle 40 may be realized by programmable circuitry or dedicated circuitry as the controller 41. That is, some or all of the functions of the vehicle 40 may be realized by hardware.

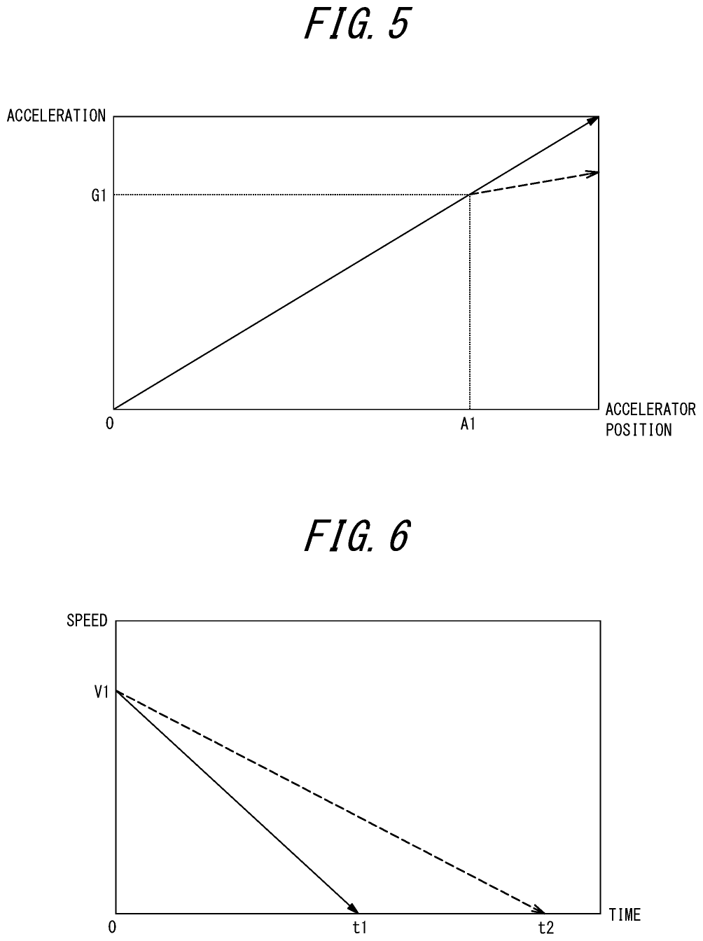

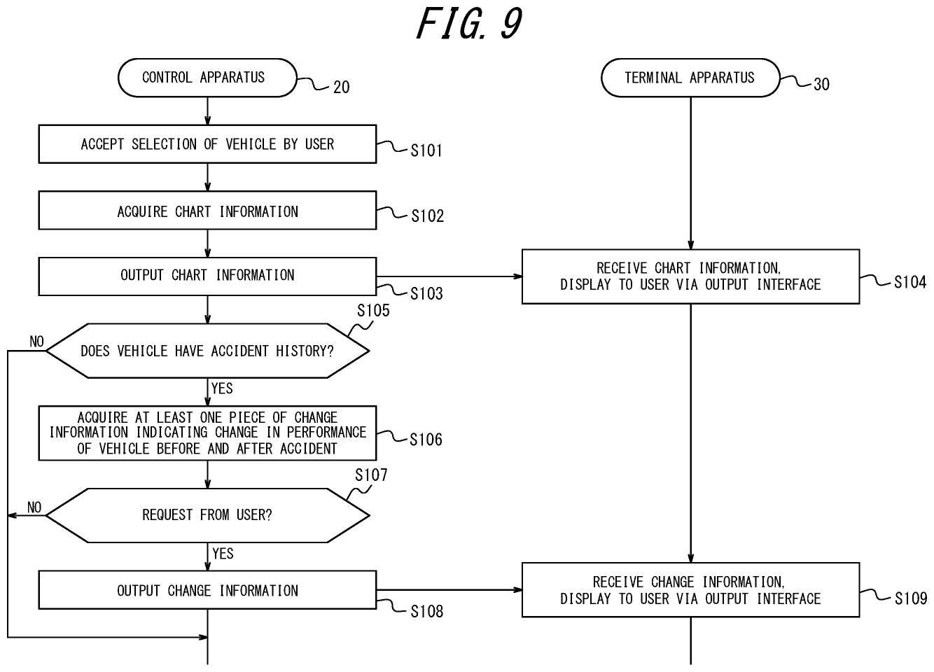

The operations of the system 10 according to the present embodiment will be described with reference to FIGS. 5, 6, 7, 8, and 9. These operations correspond to a control method according to the present embodiment. FIGS. 5, 6, 7, and 8 illustrate examples of change information according to the present embodiment. FIG. 9 illustrates a processing flow of the entire system 10 according to the present embodiment. In the following, the control apparatus 20 transmits and receives information to and from the terminal apparatus 30 and the vehicle 40 via the communication interface 23.

In step S101, the controller 21 of the control apparatus 20 accepts a selection of the vehicle 40 by the user 11.

Any appropriate method can be used to accept the selection of the vehicle 40 by the user 11. For example, the controller 31 of the terminal apparatus 30 may display a screen, via the output interface 35, for the user 11 to select from a plurality of vehicles. In this case, the controller 31 transmits information to the control apparatus 20 indicating the vehicle 40 selected by the user 11 via the input interface 34. The controller 21 of the control apparatus 20 accepts the selection, by the user 11, of the vehicle 40 by receiving this information from the terminal apparatus 30.

In step S102, the controller 21 acquires chart information for the selected vehicle 40.

The chart information is information indicating the most recent condition of the vehicle 40. The chart information is information indicating any number that identifies the vehicle 40; the degree of deterioration or existence of an abnormality for various parts of the vehicle 40 such as the engine, battery, or tires; the distance traveled; use of the hazard lights; maintenance records; the year, model, and date of manufacture of the vehicle 40; and the like. Maintenance records may specifically include a history of part replacement, details of repairs, results of vehicle inspections, and the like. The information contained in the chart information is not limited to these examples and may include information indicating various items that affect the appraisal of the vehicle 40.

Any appropriate method may be used to acquire the chart information. For example, the controller 21 may generate the chart information based on information indicating detection values detected by various sensors in the vehicle 40. In this case, the detection values are constantly or periodically transmitted from the vehicle 40 to the control apparatus 20. Specifically, the detection values detected by the various sensors in the vehicle 40 are outputted to the controller 41, and the controller 41 transmits information indicating the detection values to the control apparatus 20 via the communication interface 43. The controller 21 of the control apparatus 20 acquires the chart information for the vehicle 40 by generating the chart information for the vehicle 40 based on the received information. This example is not limiting, and the controller 21 may acquire the chart information by receiving the chart information from an external apparatus.

The chart information may be updated each time maintenance is performed on the vehicle 40, for example. Specifically, the person in charge of the business performing the maintenance enters the maintenance record on the vehicle 40, and information indicating the maintenance record is transmitted from the vehicle 40 to the control apparatus 20. The control apparatus 20 receives this information continuously or periodically and updates the chart information. The information indicating the maintenance record may be transmitted to the control apparatus 20 from a terminal apparatus used by the person in charge or the like.

In step S103, the controller 21 outputs the acquired chart information.

Any method may be used to output the chart information. In the present example, the controller 21 outputs chart information by transmitting the chart information to the terminal apparatus 30. This example is not limiting, and the controller 21 may output the chart information directly via the output interface 25.

In step S104, the controller 31 of the terminal apparatus 30 receives the chart information from the control apparatus 20 via the communication interface 33 and displays the chart information to the user via the output interface 35. By referring to the chart information displayed on the screen as the output interface 35, the user 11 can recognize the most recent condition of the vehicle 40.

In step S105, the controller 21 determines whether the vehicle 40 has an accident history. In a case in which an accident history is determined to exist, the processing by the controller 21 proceeds to step S106. In a case in which an accident history is determined not to exist, the processing by the controller 21 ends.

Any method may be used to determine whether an accident history exists. For example, in a case in which the chart information includes an accident flag indicating the existence of an accident history, the controller 21 determines that the vehicle 40 has an accident history when the accident flag is set to ON and that the vehicle 40 does not have an accident history when the accident flag is set to OFF. The accident flag included in the chart information may be set by the person in charge of the business that performed repairs on the vehicle 40 after the accident. The chart information also includes information indicating the date and time of the accident along with the accident flag. This enables the controller 21 also to acquire the date and time of the accident in a case in which the vehicle 40 is determined to have an accident history.

In step S106, the controller 21 acquires at least one piece of change information indicating a change in performance of the vehicle 40 before and after an accident.

Any appropriate method may be used to acquire the change information. For example, the controller 21 uses sensor information acquired at any date and time before the date and time of the accident to generate first performance information indicating the performance of the vehicle 40 before the date and time of the accident and uses sensor information acquired at any date and time after the date and time of the accident to generate second performance information indicating the performance of the vehicle 40 after the date and time of the accident. The controller 21 may acquire the detection values indicated by the sensor information multiple times before and after the date and time of the accident and generate graphs as the first performance information and second performance information by linear or curvilinear approximation of the detection values. The controller 21 generates change information that combines and compares the first performance information and the second performance information. The change information is information that indicates the change in any performance, such as the driving performance, stopping performance, or steering performance, as explained below. This example is not limiting, and the change information may include, for example, information indicating a change in the air conditioning performance, acoustic performance, or the like inside the vehicle 40. The controller 21 may generate the change information based on control values indicating the amount of control of various components of the vehicle 40.

FIG. 5 illustrates an example of change information that includes first performance information indicating the driving performance of the vehicle 40 before the date and time of the accident and second performance information indicating the driving performance of the vehicle 40 after the date and time of the accident. In FIG. 5, the first performance information is indicated by a solid arrow and the second performance information by a dashed arrow. The horizontal axis in FIG. 5 represents the accelerator position of the vehicle 40 and the vertical axis represents the acceleration of the vehicle 40. The range of values for the horizontal and vertical axes in FIG. 5 may be set freely.

The controller 21 acquires sensor information including the value of the accelerator position detected by the accelerator sensor 472 and the value of the acceleration detected by the speed sensor 471 at any date and time before the date and time of the accident and generates a graph indicating the relationship between the value of the accelerator position and the acceleration as the first performance information. The controller 21 further acquires sensor information including the value of the accelerator position detected by the accelerator sensor 472 and the value of the acceleration detected by the speed sensor 471 at any date and time after the date and time of the accident and generates a graph indicating the relationship between the value of the accelerator position and the acceleration as the second performance information. As illustrated in FIG. 5, the controller 21 generates the change information that combines and compares the first performance information and the second performance information.

FIG. 5 illustrates that when the value of the accelerator position of the vehicle 40 is A1, the corresponding acceleration value is G1. For values of the accelerator position of A1 or higher, it is clear that the rate of increase in the acceleration value is lower after the date and time of the accident than before the date and time of the accident. In this way, in FIG. 5, the first performance information and second performance information indicate the driving performance of the vehicle 40. The change information indicating the driving performance is not limited to the example illustrated in FIG. 5, and a graph indicating the engine ignition timing, a torque map, or the like may be generated as the change information.

FIG. 6 illustrates another example of change information generated by the controller 21. In FIG. 6, the first performance information is indicated by a solid arrow and the second performance information by a dashed arrow. The horizontal axis in FIG. 6 represents the time elapsed since the brake pedal was operated in the vehicle 40, and the vertical axis represents the speed of the vehicle 40. The range of values for the horizontal and vertical axes in FIG. 6 may be set freely. The horizontal axis in FIG. 6 may, for example, be the distance traveled by the vehicle 40 before coming to a stop, i.e., the braking distance. In this case, the controller 21 may generate a graph including the first performance information and second performance information as change information based on positional information for the vehicle 40 detected by the positioner 46 of the vehicle 40.

The controller 21 acquires sensor information including the length of time elapsed from the time, detected by the brake sensor 473, at which the brake pedal was activated and the speed of the vehicle 40 detected by the speed sensor 471 at any date and time before the date and time of the accident and generates a graph indicating the relationship between the time and speed as the first performance information. The controller 21 further acquires sensor information including the length of time elapsed from the time, detected by the brake sensor 473, at which the brake pedal was activated and the speed of the vehicle 40 detected by the speed sensor 471 at any date and time after the date and time of the accident and generates a graph indicating the relationship between the time and speed as the second performance information. As illustrated in FIG. 6, the controller 21 generates the change information that combines and compares the first performance information and the second performance information.

From the change information illustrated in FIG. 6, it is clear that in a case in which the brake pedal is activated in the vehicle 40 at speed V 1, it takes time t1 for the vehicle 40 to stop before the date and time of the accident, whereas it takes time t2 after the date and time of the accident. In other words, from the date and time of the accident onwards, the deceleration of the vehicle 40 has decreased and the braking time of the vehicle 40 has increased. In this way, in FIG. 6, the first performance information and second performance information indicate the stopping performance of the vehicle 40.

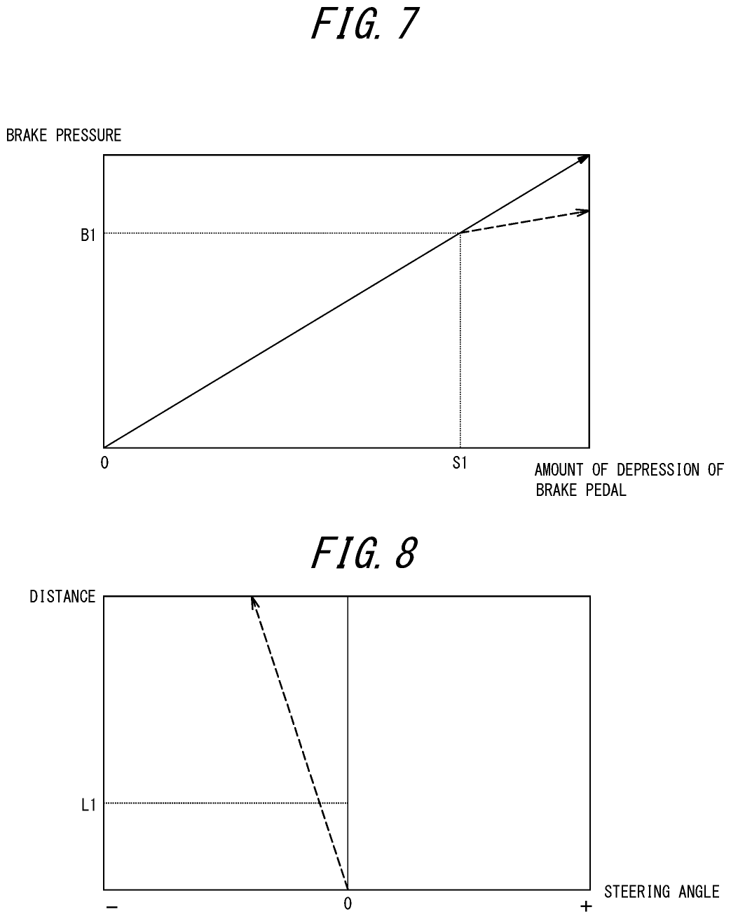

FIG. 7 illustrates another example of change information generated by the controller 21. In FIG. 7, the first performance information is indicated by a solid arrow and the second performance information by a dashed arrow. The horizontal axis in FIG. 7 represents the amount of depression of the brake pedal in the vehicle 40, and the vertical axis represents the brake pressure. The range of values for the horizontal and vertical axes in FIG. 7 may be set freely.

The controller 21 acquires sensor information including the amount of depression of the brake pedal detected by the brake sensor 473 and the brake pressure detected by the brake pressure sensor at any date and time before the date and time of the accident and generates a graph indicating the relationship between the amount of depression of the brake pedal and the brake pressure as the first performance information. The controller 21 further acquires sensor information including the amount of depression of the brake pedal detected by the brake sensor 473 and the brake pressure detected by the brake pressure sensor at any date and time after the date and time of the accident and generates a graph indicating the relationship between the amount of depression of the brake pedal and the brake pressure as the second performance information. As illustrated in FIG. 7, the controller 21 generates the change information that combines and compares the first performance information and the second performance information.

FIG. 7 illustrates that when the amount of depression of the brake pedal of the vehicle 40 is Si, the corresponding brake pressure is B 1. For an amount of depression of the brake pedal greater than Si, it is clear that the rate of increase in the brake pressure is lower after the date and time of the accident than before the date and time of the accident. In this way, in FIG. 7, the first performance information and second performance information indicate the stopping performance of the vehicle 40.

FIG. 8 illustrates another example of change information generated by the controller 21. In FIG. 8, the first performance information is indicated by a solid arrow and the second performance information by a dashed arrow. The horizontal axis in FIG. 8 represents the steering angle of the steering wheel of the vehicle 40 in a case in which the vehicle 40 moves from one arbitrary location to another arbitrary location. A negative value indicates that the steering wheel is turned to the left, and a positive value indicates being turned to the right. The vertical axis represents the distance traveled in a straight line by the vehicle 40. The range of values for the horizontal and vertical axes in FIG. 8 may be set freely.

The controller 21 acquires sensor information including the steering angle of the steering wheel of the vehicle 40 detected by the steering angle sensor 474 and the distance traveled by the vehicle 40 based on the positional information detected by the positioner 46 at any date and time before the date and time of the accident and generates a graph indicating the relationship between the steering angle and the distance traveled as the first performance information. The controller 21 further acquires sensor information including the steering angle of the steering wheel detected by the steering angle sensor 474 and the distance traveled by the vehicle 40 based on the positional information detected by the positioner 46 at any date and time after the date and time of the accident and generates a graph indicating the relationship between the steering angle and the distance traveled as the second performance information. As illustrated in FIG. 8, the controller 21 generates the change information that combines and compares the first performance information and the second performance information.

To measure the distance traveled in a straight line, the controller 21 acquires sensor information including the total steering angle of the steering wheel detected when the road on which the vehicle 40 is traveling is a straight road. The controller 21 may be able to acquire positional information for another vehicle different from the vehicle 40 and the steering angle of the steering wheel of the other vehicle and determine that the road is a straight road based on this information. The controller 21 may use past positional information for the vehicle 40 to identify a straight road on which the vehicle 40 travels regularly and acquire the sensor information detected when the vehicle 40 travels on that road.

From the change information illustrated in FIG. 8, it is clear that in order for the vehicle 40 to move straight ahead by a distance L1, the steering angle of the steering wheel was zero, i.e., the steering wheel could be kept straight, before the date and time of the accident, whereas the steering angle of the steering wheel needed to be a negative value, i.e., the steering wheel needed to be turned left, after the date and time of the accident. In this way, in FIG. 8, the first performance information and second performance information indicate the steering performance of the vehicle 40. The change information indicating the steering performance is not limited to the example illustrated in FIG. 8 and may, for example, be a graph indicating how much the vehicle 40 veers left or right when the steering angle is zero, i.e., when the steering wheel is kept straight.

The methods for generating the first performance information and second performance information are not limited to the methods described above. For example, the controller 21 may continuously acquire the positional information for the vehicle 40, generate the first performance information and second performance information based on sensor information acquired when the vehicle 40 passes a predetermined location, and then generate the change information. The predetermined location is, for example, a road near the home of the driver of the vehicle 40. This enables the controller 21 to generate the change information based on sensor information for identical road conditions.

In the present example, the controller 21 combines the first information and the second information to generate a two-dimensional graph as the change information, but the format of the change information is not limited to this example. A graph of any appropriate format may be generated as the change information.

As illustrated in step S106, the controller 21 communicates with the vehicle 40 via the communication interface 23 to acquire sensor information indicating a detection result from at least one sensor installed in the vehicle 40 and acquires the change information by generating the change information based on the sensor information.

In step S107, the controller 21 determines whether a request has been made by the user 11. In a case in which it is determined that the user 11 has made a request, the processing by the controller 21 proceeds to step S108. In a case in which it is determined that the user 11 has not made a request, the processing by the controller 21 ends.

Any method can be used to determine whether the user 11 has made a request. For example, the controller 31 of the terminal apparatus 30 displays a button for accepting a request to display the change information via the output interface 35 and accepts any appropriate operation, such as clicking the button, by the user 11 via the input interface 34. In this case, the controller 31 transmits information indicating the operation to the control apparatus 20 via the communication interface 33. The appropriate operations may include flicking, dragging, or the like. The controller 21 of the control apparatus 20 determines that the user 11 has made a request based on the received information indicating the operation.

In step S108, the controller 21 outputs the acquired change information.

Any method may be used to output the change information. For example, the controller 21 outputs the change information by transmitting the change information to the terminal apparatus 30. The change information may be outputted for the driving performance, stopping performance, or steering performance of the vehicle 40, or for more than one of these performances, according to the request by the user 11. The change information may be outputted in part or in whole. The controller 21 may output the change information via the output interface 25. In this case, the user 11 can refer to the change information displayed on the screen as the output interface 25 of the control apparatus 20.

In step S109, the controller 31 of the terminal apparatus 30 receives the change information from the control apparatus 20 via the communication interface 33 and displays the change information to the user 11 via the output interface 35. This enables the user 11 to refer to the change information in addition to the chart information displayed in step S104. Subsequently, operations by the system 10 end.

For example, the controller 31 of the terminal apparatus 30 may display a button on the screen as the output interface 25 to allow selection of the chart information and the change information and may switch between displaying the chart information and the change information on the screen according to the selection of the button by the user 11. The change information may be provided to the user 11 by being outputted as audio or the like via a speaker of the terminal apparatus 30, for example.

As illustrated in steps S102 to S109, the controller 21 acquires chart information indicating the most recent condition of the vehicle 40 and switches between outputting the chart information and the change information according to a request by the user 11.

As described above, in the present embodiment, the control apparatus 20 includes the controller 21 that acquires, based on whether a vehicle selected by the user 11 has an accident history, at least one piece of change information indicating a change in performance of the vehicle before and after an accident and outputs the acquired change information.

In a case in which the vehicle 40 has an accident history, the user 11 can learn in detail how the performance of the vehicle 40 has changed by referring to the change information. This change information becomes useful for making a decision in a case in which the user 11 is considering whether to purchase the vehicle 40 or is determining the appraised value of the vehicle 40. A method of providing information that affects the appraisal when the vehicle has an accident history can thus be improved.

As described above, in the present embodiment, the controller 21 acquires chart information indicating the most recent condition of the vehicle 40 and switches between outputting the chart information and the change information according to a request by the user 11.

In a case in which the user 11 wishes to learn about changes in the performance of the vehicle 40 before and after an accident, the user 11 can refer to the change information as information indicating the basis for the change. In this way, output of the chart information and the change information is switched according to a request by the user 11, which improves convenience for the user 11. A method of providing information that affects the appraisal when the vehicle 40 has an accident history can thus be improved.

As described above, in the present embodiment, the change information includes first performance information indicating the performance of the vehicle 40 before the date and time of the accident and second performance information indicating the performance of the vehicle 40 after the date and time of the accident. The controller 21 outputs information indicating the first performance information and the second performance information in a graph as the change information.

The change information includes the first performance information and the second performance information separately and is presented in a graph, which makes it easier for the user 11 to understand the change in performance compared to a case in which the change in performance before and after an accident is represented by only one number, for example. A method of providing information that affects the appraisal when the vehicle 40 has an accident history can thus be improved.

As described above, in the present embodiment, the first performance information and the second performance information each indicate a driving performance, a stopping performance, and/or a steering performance of the vehicle 40.

The change information on at least one basic performance of the vehicle 40, i.e., the driving performance, the stopping performance, and the steering performance, serves as a basis for the user 11 to make a decision when considering to purchase or when appraising the vehicle 40. A method of providing information that affects the appraisal when the vehicle 40 has an accident history can thus be improved.

As described above, in the present embodiment, the controller 21 communicates with the vehicle 40 via the communication interface 23 to acquire sensor information indicating a detection result from at least one sensor installed in the vehicle 40 and generates the change information based on the sensor information.

By the change information being generated based on sensor information constantly or periodically acquired from the vehicle 40, more accurate change information is provided to the user 11. A method of providing information that affects the appraisal when the vehicle 40 has an accident history can thus be improved.

(First Variation)

Next, a first variation of an embodiment of the present disclosure is described. In the present variation, the controller 21 determines whether the vehicle 40 has an accident history based on the sensor information.

The configurations of the system 10, the control apparatus 20, the terminal apparatus 30, and the vehicle 40 according to the present variation are the same as in the embodiment described above, and hence a description thereof is omitted.

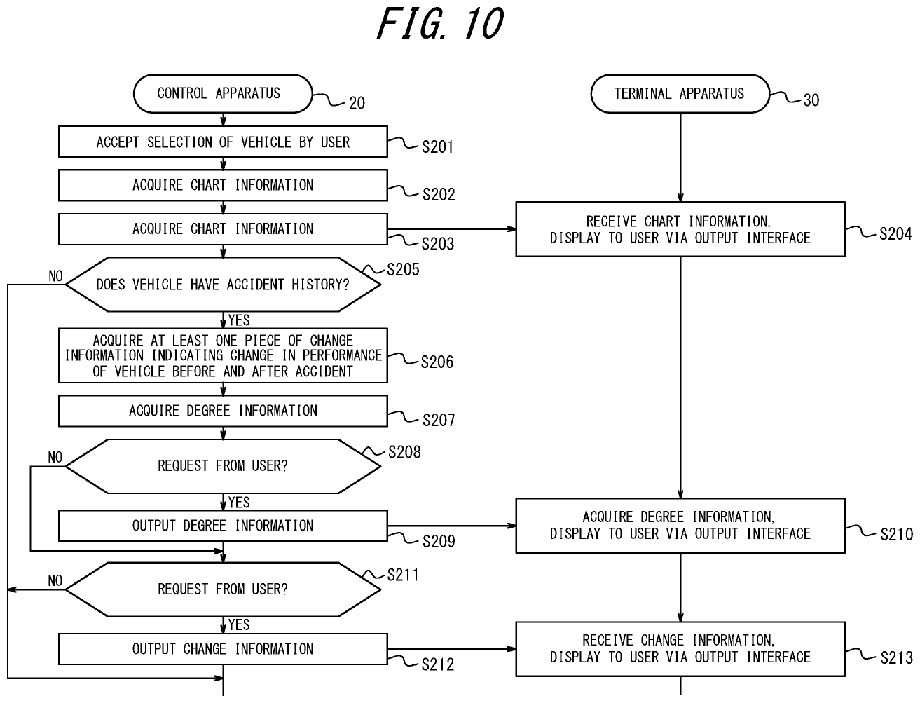

The differences between the operations of the system 10 according to the embodiment described above and the system 10 according to the present variation are explained below with reference to FIG. 10.

Steps S201 through S206 in FIG. 5 are similar to steps S101 through S106 in FIG. 2 according to the embodiment described above, and hence a description thereof is omitted.

In step S207, the controller 21 acquires degree information indicating a degree of change in the performance of the vehicle 40 before and after the accident.

Any appropriate method may be used to acquire the degree information. For example, the controller 21 may acquire the degree information by calculating the difference between the slope of the graph of the first performance information and the slope of the graph of the second performance information included in the change information acquired in step S206, reading a reference value from the memory 22, and generating the result of a comparison between the reference value and the calculated difference as the degree information. The reference value may be any predetermined value and may be set in stages. The reference value may be set by taking into account the aging of various components of the vehicle 40. For example, two types of reference values, i.e., a first reference value and a second reference value, may be set in order of decreasing degree of change. In this case, the controller 21 determines that the degree of change is “small” in a case in which the calculated difference between the slope of the graph of the first performance information and the slope of the graph of the second performance information is less than the first reference value, determines that the degree of change is “medium” in a case in which the difference is less than the second reference value, and determines that the degree of change is “large” in a case in which the difference is greater than or equal to the second reference value. The controller 21 then generates information indicating “small”, “medium”, or “large” for change information as the degree information. For example, suppose the first reference value is 5 degrees, the second reference value is 20 degrees, and the difference between the slope of the graph of the first performance information and the slope of the graph of the second performance information calculated by the controller 21 is 10 degrees. Since the difference is less than the second reference value, the controller 21 determines that the degree of change is “medium” and generates information indicating that the degree of change is “medium” as the degree information.

In step S208, the controller 21 determines whether the user 11 has requested the degree information. In a case in which it is determined that the user 11 has made a request, the processing by the controller 21 proceeds to step S209. In a case in which it is determined that the user 11 has not made a request, the processing by the controller 21 proceeds to step S211.

Any method can be used to determine whether the user 11 has made a request. For example, the controller 31 of the terminal apparatus 30 displays a button to accept a request to display the degree information via the output interface 35 and accepts any user operation, such as clicking the button, via the input interface 34. In this case, the controller 31 transmits information indicating the operation to the control apparatus 20 via the communication interface 33. The controller 21 of the control apparatus 20 determines that the user 11 has made a request based on the received information indicating the operation.

In step S209, the controller 21 outputs the acquired degree information.

Any method may be used to output the degree information. For example, the controller 21 outputs the degree information by transmitting the degree information to the terminal apparatus 30. The controller 21 may output the degree information via the output interface 25. In this case, the user 11 can refer to the degree information displayed on the screen as the output interface 25 of the control apparatus 20.

As illustrated in steps S207 to S209, the controller 21 acquires degree information indicating the degree of change in the performance of the vehicle 40 before and after the accident and outputs the degree information according to a request by the user 11.

In step S210, the controller 31 of the terminal apparatus 30 receives the degree information from the control apparatus 20 via the communication interface 33 and displays the degree information to the user 11 via the output interface 35. This enables the user 11 to refer to the degree information in addition to the chart information.

Steps S211 through S213 in FIG. 10 are similar to steps S107 through S109 in FIG. 9 according to the embodiment described above, and hence a description thereof is omitted.

As illustrated in steps S208 through S213, the controller 21 can additionally output the change information after first outputting the degree information according to the request by the user 11. This enables the user 11 to additionally request the change information when, for example, the user 11 sees degree information indicating a “medium” degree of change in the performance of the vehicle 40 before and after the accident and wishes to know more details about the change. By referring to the change information additionally outputted from the control apparatus 20 to the terminal apparatus 30, the user 11 can incrementally learn more about the change before and after the accident of the vehicle 40.

As described above, in the control apparatus 20 of the present variation, the controller 21 acquires degree information indicating the degree of change in the performance of the vehicle 40 before and after the accident and outputs the degree information according to a request by the user 11.

According to the present variation, the controller 21 can first provide the user 11 with rough information about the change in performance of the vehicle 40 before and after the accident. The change information can be further provided in a case in which the user 11 wishes to know about the change in the performance of the vehicle 40 in more detail by referring to the degree information. Providing information about changes in the performance of the vehicle 40 in stages improves convenience for the user 11. A method of providing information that affects the appraisal when the vehicle 40 has an accident history can thus be improved.

(Second Variation)

Next, a second variation of an embodiment of the present disclosure is described. In the present variation, the controller 21 determines whether the vehicle 40 has an accident history based on the sensor information.

Since the configuration of the system 10 according to the present variation is similar to that of the embodiment described above, a description thereof is omitted.

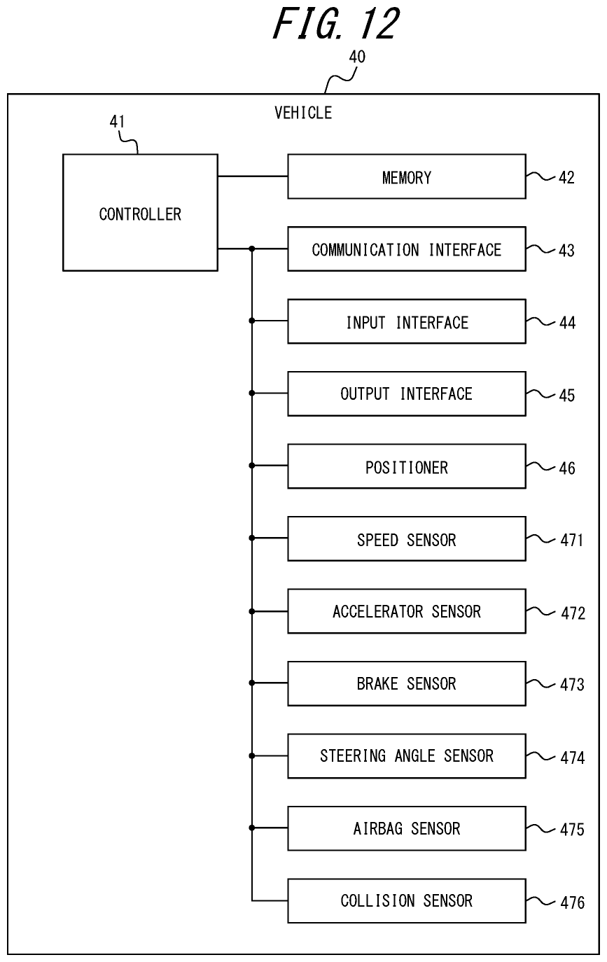

In the present variation, as illustrated in FIG. 12, the vehicle 40 further includes an airbag sensor 475 and a collision sensor 476.

The airbag sensor 475 detects that an airbag included in the vehicle 40 has deployed and outputs a signal indicating the detection result to the controller 21. The collision sensor 476 detects the impact value acting on the vehicle 40 during a collision of the vehicle 40 and outputs a signal indicating the detection result to the controller 21.

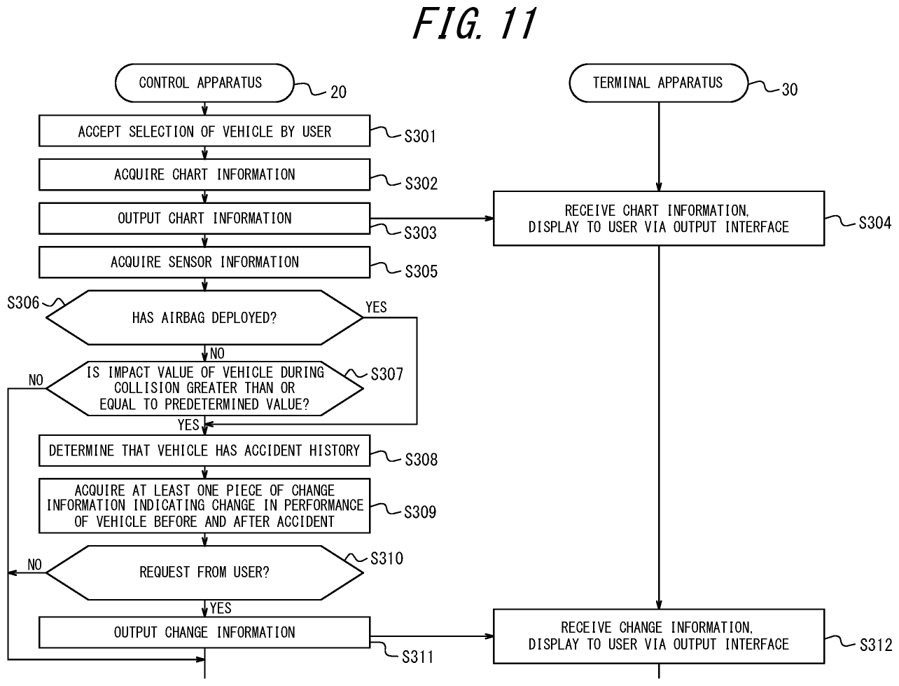

The differences between the operations of the system 10 according to the embodiment described above and the system 10 according to the present variation are explained below with reference to FIG. 11.

Steps S301 through S304 in FIG. 11 are similar to steps S101 through S104 in FIG. 9 according to the embodiment described above, and hence a description thereof is omitted.

In step S305, the controller 21 communicates with the vehicle 40 via the communication interface 23 and acquires sensor information from the vehicle 40. In the present variation, the sensor information includes airbag deployment information, detected by the airbag sensor 475, indicating that the airbag has deployed and impact value information, detected by the collision sensor 476, indicating the impact value of the vehicle 40 during a collision.

In step S306, the controller 21 determines whether the airbag has deployed in the vehicle 40 based on the airbag deployment information.

In a case in which the airbag deployment information indicates that the airbag has deployed, the controller 21 determines that the airbag has deployed, and operations by the controller 21 proceed to step S308. In a case in which the airbag deployment information does not indicate that the airbag has deployed, the controller 21 determines that the airbag has not deployed, and operations by the controller 21 proceed to step S307.

Next, the case is described in which it is determined in step S306 that the airbag has not deployed, and the processing by the controller 21 proceeds to step S307. In step S307, the controller 21 determines whether the impact value of the vehicle 40 during the collision is greater than or equal to a predetermined value. In a case in which the impact value is less than a predetermined value, the controller 21 determines that the vehicle 40 does not have an accident history, and the processing by the controller 21 ends. In a case in which the impact value is greater than or equal to a predetermined value, the operations by the controller 21 proceed to step S308.

The case is described in which it is determined in step S306 that the airbag has deployed, or it is determined in step S307 that the impact value is greater than or equal to a predetermined value, and the processing by the controller 21 proceeds to step S308. In step S308, the controller 21 determines that the vehicle 40 has an accident history. The processing by the controller 21 then proceeds to step S309.

Steps S309 through S312 are similar to steps S106 through S109 in FIG. 9 according to the embodiment described above, and hence a description thereof is omitted.

As described above, in the control apparatus 20 according to the present variation, the sensor information includes airbag deployment information indicating that the airbag has deployed and impact value information indicating the impact value of the vehicle 40 during a collision. The controller 21 determines whether the vehicle 40 has an accident history based on the airbag deployment information and the impact value information.

According to the present variation, the controller 21 can more accurately determine whether the vehicle 40 has an accident history based on the airbag deployment information and the impact value information. It can be determined that the vehicle 40 had an accident not only in the case of the airbag having been deployed, but also when a predetermined impact value or higher is registered, even if the airbag did not deploy. In other words, even a minor collision can accurately be determined as an accident. A method of providing information that affects the appraisal when the vehicle 40 has an accident history can thus be improved.

The present disclosure is not limited to the embodiment described above. For example, a plurality of blocks described in the block diagrams may be integrated, or a block may be divided. Instead of executing a plurality of steps described in the flowcharts in chronological order in accordance with the description, the plurality of steps may be executed in parallel or in a different order according to the processing capability of the apparatus that executes each step, or as required. Other modifications can be made without departing from the spirit of the present disclosure.

1. A control apparatus comprising a controller configured to:
acquire, based on whether a vehicle selected by a user has an accident history, at least one piece of change information indicating a change in performance of the vehicle before and after an accident and output the acquired change information.

2. The control apparatus according to claim 1, wherein the controller
acquires chart information indicating a most recent condition of the vehicle, and
switches between outputting the chart information and the change information according to a request by the user.

3. The control apparatus according to claim 1, wherein
the change information includes first performance information indicating the performance of the vehicle before a date and time of the accident and second performance information indicating the performance of the vehicle after the date and time of the accident, and
the controller outputs information indicating the first performance information and the second performance information in a graph as the change information.

4. The control apparatus according to claim 3, wherein the first performance information and the second performance information each indicate a driving performance, a stopping performance, and/or a steering performance of the vehicle.

5. The control apparatus according to claim 1, wherein the controller acquires degree information indicating a degree of change in the performance of the vehicle before and after the accident and outputs the degree information according to a request by the user.

6. The control apparatus according to claim 1, further comprising a communication interface, wherein the controller communicates with the vehicle via the communication interface to acquire sensor information indicating a detection result from at least one sensor installed in the vehicle and generates the change information based on the sensor information.

7. The control apparatus according to claim 6, wherein
the sensor information includes airbag deployment information indicating that an airbag has deployed and impact value information indicating an impact value of the vehicle during a collision, and
the controller determines whether the vehicle has an accident history based on the airbag deployment information and the impact value information.

8. A control method to be executed by a computer, the method comprising:
acquiring, based on whether a vehicle selected by a user has an accident history, at least one piece of change information indicating a change in performance of the vehicle before and after an accident and outputting the acquired change information.

9. The control method according to claim 8, further comprising
acquiring chart information indicating a most recent condition of the vehicle; and
switching between outputting the chart information and the change information according to a request by the user.

10. The control method according to claim 8, wherein
the change information includes first performance information indicating the performance of the vehicle before a date and time of the accident and second performance information indicating the performance of the vehicle after the date and time of the accident, and
the control method further comprises outputting information indicating the first performance information and the second performance information in a graph as the change information.

11. The control method according to claim 10, wherein the first performance information and the second performance information each indicate a driving performance, a stopping performance, and/or a steering performance of the vehicle.

12. The control method according to claim 8, further comprising acquiring degree information indicating a degree of change in the performance of the vehicle before and after the accident and outputting the degree information according to a request by the user.

13. The control method according to claim 8, further comprising
communicating with the vehicle; and
acquiring sensor information indicating a detection result from at least one sensor installed in the vehicle and generating the change information based on the sensor information.

14. The control method according to claim 13, wherein
the sensor information includes airbag deployment information indicating that an airbag has deployed and impact value information indicating an impact value of the vehicle during a collision, and
the control method further comprises determining whether the vehicle has an accident history based on the airbag deployment information and the impact value information.

15. A non-transitory computer readable medium storing a program configured to cause a computer to execute operations, the operations comprising:
acquiring, based on whether a vehicle selected by a user has an accident history, at least one piece of change information indicating a change in performance of the vehicle before and after an accident and outputting the acquired change information.

16. The non-transitory computer readable medium according to claim 15, wherein the program is configured to cause the computer to execute operations further comprising
acquiring chart information indicating a most recent condition of the vehicle; and
switching between outputting the chart information and the change information according to a request by the user.

17. The non-transitory computer readable medium according to claim 15, wherein
the change information includes first performance information indicating the performance of the vehicle before a date and time of the accident and second performance information indicating the performance of the vehicle after the date and time of the accident, and
the program is configured to cause the computer to execute operations further comprising outputting information indicating the first performance information and the second performance information in a graph as the change information.

18. The non-transitory computer readable medium according to claim 17, wherein the first performance information and the second performance information each indicate a driving performance, a stopping performance, and/or a steering performance of the vehicle.

19. The non-transitory computer readable medium according to claim 15, wherein the program is configured to cause the computer to execute operations further comprising acquiring degree information indicating a degree of change in the performance of the vehicle before and after the accident and outputting the degree information according to a request by the user.

20. The non-transitory computer readable medium according to claim 15, wherein the program is configured to cause the computer to execute operations further comprising
communicating with the vehicle; and
acquiring sensor information indicating a detection result from at least one sensor installed in the vehicle and generating the change information based on the sensor information.
